(19) United States
(12) Patent Application Publication
(10) Pub. No.: US 2023/0093849 A1
(43) Pub. Date: Mar. 30, 2023

(54) IMAGE PROCESSING DEVICE, IMAGE PROCESSING METHOD, AND IMAGE PROCESSING PROGRAM

(71) Applicant: FUJIFILM Corporation, Tokyo (JP)

(72) Inventor: Tomoyuki TAKAHASHI, Kanagawa-ken (JP)

(73) Assignee: FUJIFILM Corporation, Tokyo (JP)

(21) Appl. No.: 17/898,157

(22) Filed: Aug. 29, 2022

(30) Foreign Application Priority Data
Sep. 29, 2021 (JP) 2021-159996

(51) Int. Cl. G06T 5/50; G06T 7/00

(52) U.S. Cl. CPC G06T 5/50; G06T 7/0012; G06T 2207/30008; G06T 2207/20221

(57) ABSTRACT

A processor derives a bone part image of a subject including a bone part from a first radiation image and a second radiation image acquired by imaging the subject with radiation having different energy distributions, derives a bone density image representing bone density in a bone region of the subject from the bone part image, derives a trabecula image representing a trabecula structure from the first radiation image, the second radiation image, or the bone part image, and superimposes the trabecula image on the bone density image to display the trabecula image and the bone density image.

### CROSS REFERENCE TO RELATED APPLICATIONS

The present application claims priority under 35 U.S.C. § 119 to Japanese Patent Application No. 2021-159996 filed on Sep. 29, 2021. The above application is hereby expressly incorporated by reference, in its entirety, into the present application.

### BACKGROUND

### Technical Field

The present disclosure relates to an image processing device, an image processing method, and an image processing program.

### Related Art

In the related art, a method of acquiring and displaying information on the strength of a bone of a human body from a radiation image has been proposed. For example, in JP2019-202035A, a method of acquiring a bone part image representing a bone part of a subject by energy subtraction processing, acquiring bone mineral information from the bone part image, deriving a distribution of bone strength from the bone mineral information and an index value related to density of trabecula structure of the bone, and displaying the distribution of the bone strength in different colors has been proposed. In addition, in JP2021-069791A, a method of deriving an image representing a distribution of bone mass, that is, bone density derived from a radiation image, acquiring a trabecula image representing a trabecula structure in accordance with the bone density separately from the radiation image, and displaying a distribution image of the bone density and the trabecula image has been proposed.

However, in the method disclosed in JP2019-202035A, the bone strength can be confirmed in the displayed image, but the trabecula structure cannot be confirmed. In addition, in the method disclosed in JP2021-069791A, the trabecula image is not derived from the radiation image of the subject, so that it is necessary to separately perform imaging for acquiring the trabecula image. In addition, in the method disclosed in JP2021-069791A, the distribution image of the bone density and the trabecula image are separately displayed, so that the bone density and the trabecula structure cannot be confirmed at a glance.

### SUMMARY OF THE INVENTION

The present disclosure has been made in view of the above circumstances, and is to make it possible to confirm the bone density and the trabecula structure at a glance.

An image processing device according to the present disclosure comprises at least one processor, in which the processor derives a bone part image of a subject including a bone part from a first radiation image and a second radiation image acquired by imaging the subject with radiation having different energy distributions, derives a bone density image representing bone density in a bone region of the subject from the bone part image, derives a trabecula image representing a trabecula structure from the first radiation image, the second radiation image, or the bone part image, and superimposes the trabecula image on the bone density image to display the trabecula image and the bone density image.

Note that, in the image processing device according to the present disclosure, the processor may derive a high-frequency component of the first radiation image, the second radiation image, or the bone part image as the trabecula image.

In this case, the processor may derive an enhanced high-frequency component as the trabecula image.

In addition, in the image processing device according to the present disclosure, the processor may derive the bone density of each pixel in the bone region, and may derive the bone density image having a low-frequency component of a distribution of the bone density as a pixel value.

In addition, in the image processing device according to the present disclosure, the processor may derive the bone density of each pixel in the bone region, and may derive the bone density image having a representative value of the bone density in the bone region as a pixel value.

In addition, in the image processing device according to the present disclosure, the bone density image may have a color distribution corresponding to the bone density.

In addition, in the image processing device according to the present disclosure, the trabecula image may have a color different from the bone density.

An image processing method according to the present disclosure comprises deriving a bone part image of a subject including a bone part from a first radiation image and a second radiation image acquired by imaging the subject with radiation having different energy distributions, deriving a bone density image representing bone density in a bone region of the subject from the bone part image, deriving a trabecula image representing a trabecula structure from the first radiation image, the second radiation image, or the bone part image, and superimposing the trabecula image on the bone density image to display the trabecula image and the bone density image.

Note that a program causing a computer to execute the image processing method according to the present disclosure may be provided.

According to the present disclosure, the bone density and the trabecula structure can be confirmed at a glance.

### BRIEF DESCRIPTION OF THE DRAWINGS

FIG. 1 is a schematic block diagram showing a configuration of a radiography system to which an image processing device according to an embodiment of the present disclosure is applied.

FIG. 2 is a diagram showing a schematic configuration of the image processing device according to the present embodiment.

FIG. 3 is a diagram showing a functional configuration of the image processing device according to the present embodiment.

FIG. 4 is a diagram showing a soft part image.

FIG. 5 is a diagram showing a relationship between a contrast of a bone part and a soft part with respect to a body thickness.

FIG. 6 is a diagram showing an example of a look-up table for acquiring a correction coefficient.

FIG. 7 is a cross-sectional view of a vertebra.

FIG. 8 is a diagram showing a trabecula image.

FIG. 9 is a diagram showing a mapping image of bone density.

FIG. 10 is a diagram showing a display screen.

FIG. 11 is a flowchart showing processing performed in the present embodiment.

### DETAILED DESCRIPTION

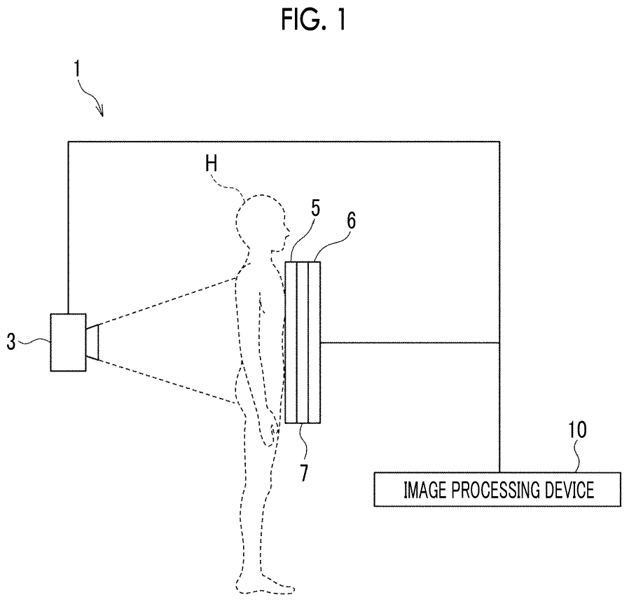

Hereinafter, embodiments of the present disclosure will be described with reference to the drawings. FIG. 1 is a schematic block diagram showing a configuration of a radiography system to which an image processing device according to the embodiment of the present disclosure is applied. As shown in FIG. 1, the radiography system according to the present embodiment comprises an imaging apparatus 1 and an image processing device 10 according to the present embodiment.

The imaging apparatus 1 is an imaging apparatus that performs energy subtraction by a so-called one-shot method of converting radiation, such as X-rays, emitted from a radiation source 3 and transmitted through a subject H into energy and irradiating a first radiation detector 5 and a second radiation detector 6 with the converted radiation. During imaging, as shown in FIG. 1, the first radiation detector 5, a radiation energy conversion filter 7 consisting of a copper plate or the like, and the second radiation detector 6 are disposed in order from a side closest to the radiation source 3, and the radiation source 3 is driven. Note that the first and second radiation detectors 5 and 6 are closely attached to the radiation energy conversion filter 7.

As a result, in the first radiation detector 5, a first radiation image G1 of the subject H by low-energy radiation including so-called soft rays is acquired. In addition, in the second radiation detector 6, a second radiation image G2 of the subject H by high-energy radiation from which the soft rays are removed is acquired. The first and second radiation images are input to the image processing device 10.

The first and second radiation detectors 5 and 6 can perform recording and reading-out of the radiation image repeatedly. A so-called direct-type radiation detector that directly receives irradiation with the radiation and generates an electric charge may be used, or a so-called indirect-type radiation detector that converts the radiation into visible light and then converts the visible light into an electric charge signal may be used. In addition, as a method of reading out a radiation image signal, it is desirable to use a so-called thin film transistor (TFT) readout method in which the radiation image signal is read out by turning a TFT switch on and off, or a so-called optical readout method in which the radiation image signal is read out by irradiation with read out light. However, other methods may also be used without being limited to these methods.

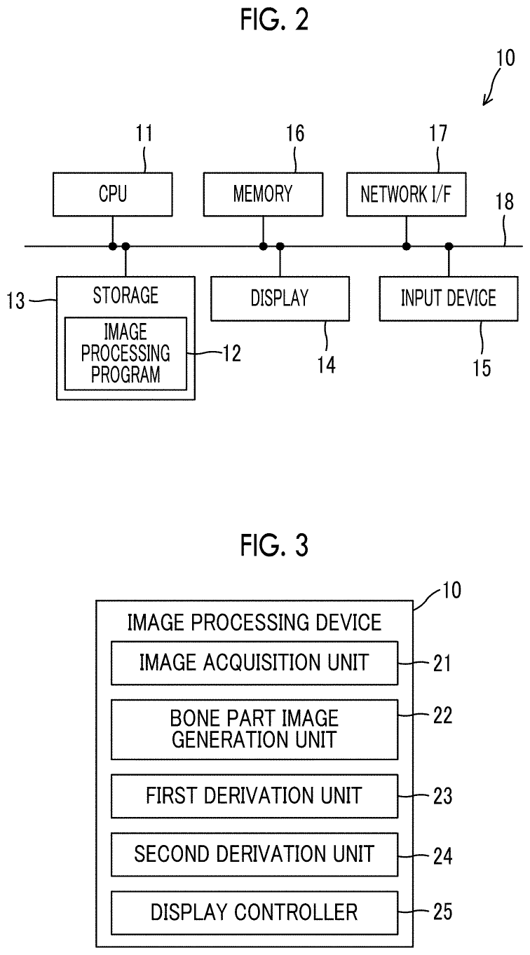

Then, the image processing device according to the present embodiment will be described. First, a hardware configuration of the image processing device according to the present embodiment will be described with reference to FIG. 2. As shown in FIG. 2, the image processing device 10 is a computer, such as a workstation, a server computer, and a personal computer, and comprises a central processing unit (CPU) 11, a non-volatile storage 13, and a memory 16 as a transitory storage region. In addition, the image processing device 10 comprises a display 14, such as a liquid crystal display, an input device 15, such as a keyboard and a mouse, and a network interface (I/F) 17 connected to a network (not shown). The CPU 11, the storage 13, the display 14, the input device 15, the memory 16, and the network I/F 17 are connected to a bus 18. Note that the CPU 11 is an example of a processor according to the present disclosure.

The storage 13 is realized by a hard disk drive (HDD), a solid state drive (SSD), a flash memory, and the like. An image processing program 12 installed in the image processing device 10 is stored in the storage 13 as a storage medium. The CPU 11 reads out the image processing program 12 from the storage 13, expands the read out image processing program 12 to the memory 16, and executes the expanded image processing program 12.

Note that the image processing program 12 is stored in a storage device of the server computer connected to the network or in a network storage in a state of being accessible from the outside, and is downloaded and installed in the computer that configures the image processing device 10 in response to the request. Alternatively, the image processing program 12 is distributed in a state of being recorded on a recording medium, such as a digital versatile disc (DVD) or a compact disc read only memory (CD-ROM), and is installed in the computer that configures the image processing device 10 from the recording medium.

Then, a functional configuration of the image processing device according to the present embodiment will be described. FIG. 3 is a diagram showing the functional configuration of the image processing device according to the present embodiment. As shown in FIG. 3, the image processing device 10 comprises an image acquisition unit 21, a bone part image generation unit 22, a first derivation unit 23, a second derivation unit 24, and a display controller 25. Moreover, by executing the image processing program 12, the CPU 11 functions as the image acquisition unit 21, the bone part image generation unit 22, the first derivation unit 23, the second derivation unit 24, and the display controller 25.

The image acquisition unit 21 acquires the first radiation image G1 and the second radiation image G2 of the subject H from the first and second radiation detectors 5 and 6 by causing the imaging apparatus 1 to perform the energy subtraction imaging of the subject H. In a case in which the first radiation image G1 and the second radiation image G2 are acquired, imaging conditions, such as an imaging dose, a radiation quality, a tube voltage, a source image receptor distance (SID) which is a distance between the radiation source 3 and surfaces of the first and second radiation detectors 5 and 6, a source object distance (SOD) which is a distance between the radiation source 3 and a surface of the subject H, and the presence or absence of a scattered ray removal grid are set.

The SOD and the SID are used to calculate a body thickness distribution as described below. It is preferable that the SOD be acquired by, for example, a time of flight (TOF) camera. It is preferable that the SID be acquired by, for example, a potentiometer, an ultrasound range finder, a laser range finder, or the like.

The imaging conditions need only be set by input from the input device 15 by an operator.

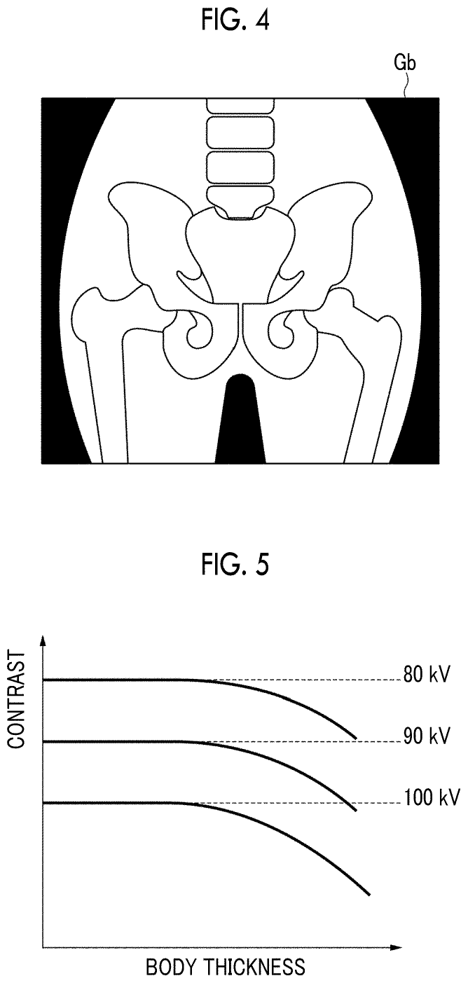

The bone part image generation unit 22 generates a bone part image Gb representing a bone region of the subject H from the first radiation image G1 and the second radiation image G2 acquired by the image acquisition unit 21. FIG. 4 shows an example of the bone part image Gb generated by the bone part image generation unit 22. Note that, in general, a lumbar vertebra or a femur is used in measurement of bone mass or a bone mineral density. Therefore, the bone part image Gb shown in FIG. 4 shows the bone part image Gb generated from the first radiation image G1 and the second radiation image G2 obtained by performing imaging to include a part of the femur and the lumbar vertebra of the subject H.

The bone part image generation unit 22 generates the bone part image Gb obtained by extracting only the bone part of the subject H included in the first radiation image G1 and the second radiation image G2 by performing weighting subtraction between the corresponding pixels, on the first radiation image G1 and the second radiation image G2, as shown in Expression (1). Note that, in Expression (1), μb is a weighting coefficient, and x and y are coordinates of each pixel of the bone part image Gb.

Gb(x,y)=G1(x,y)−μb×G2(x,y) (1)

Here, each of the first radiation image G1 and the second radiation image G2 includes a scattered ray component based on the radiation scattered in the subject H in addition to a primary ray component of the radiation transmitted through the subject H. Therefore, it is preferable to remove the scattered ray component from the first radiation image G1 and the second radiation image G2. For example, a removal method of the scattered ray component is not particularly limited, but the scattered ray component may be removed from the first radiation image G1 and the second radiation image G2 by applying a method disclosed in JP2015-043959A. In a case in which a method disclosed in JP2015-043959A or the like is used, the derivation of the body thickness distribution of the subject H and the derivation of the scattered ray component for removing the scattered ray component are performed at the same time.

Hereinafter, the removal of the scattered ray component from the first radiation image G1 will be described, but the removal of the scattered ray component from the second radiation image G2 can also be performed in the same manner. First, the bone part image generation unit 22 acquires a virtual model of the subject H having an initial body thickness distribution T0(x,y). The virtual model is data virtually representing the subject H of which a body thickness in accordance with the initial body thickness distribution T0(x,y) is associated with a coordinate position of each pixel of the first radiation image G1. Note that the virtual model of the subject H having the initial body thickness distribution T0(x,y) may be stored in the storage 13 of the image processing device 10 in advance. In addition, the bone part image generation unit 22 may calculate a body thickness distribution T(x,y) of the subject H based on the SID and the SOD included in the imaging conditions. In this case, the initial body thickness distribution T0(x,y) can be obtained by subtracting the SOD from the SID.

Next, the bone part image generation unit 22 generates, based on the virtual model, an image obtained by synthesizing an estimated primary ray image in which a primary ray image obtained by imaging the virtual model is estimated and an estimated scattered ray image in which a scattered ray image obtained by imaging the virtual model is estimated as an estimated image in which the first radiation image G1 obtained by imaging the subject H is estimated.

Next, the bone part image generation unit 22 corrects the initial body thickness distribution TO(x,y) of the virtual model such that a difference between the estimated image and the first radiation image G1 is small The bone part image generation unit 22 repeatedly performs the generation of the estimated image and the correction of the body thickness distribution until the difference between the estimated image and the first radiation image G1 satisfies a predetermined termination condition. The bone part image generation unit 22 derives the body thickness distribution in a case in which the termination condition is satisfied as the body thickness distribution T(x,y) of the subject H. In addition, the bone part image generation unit 22 removes the scattered ray component included in the first radiation image G1 by subtracting the scattered ray component in a case in which the termination condition is satisfied from the first radiation image G1.

The first derivation unit 23 derives a bone density image representing the bone density in the bone region of the subject H based on the bone part image Gb generated by the bone part image generation unit 22. The first derivation unit 23 derives a bone density image B by deriving the bone density B(x,y) for each pixel (x,y) of the bone part image Gb. Note that the bone density B(x,y) may be derived for all the bones included in the bone part image Gb, or the bone density B(x,y) may be derived only for a predetermined bone. As an example, in the present embodiment, the lumbar vertebra included in the bone part image Gb is used as the predetermined bone in the bone part image Gb, and the first derivation unit 23 derives the bone density B(x,y) for each pixel of the bone region corresponding to the lumbar vertebra and does not derive the bone density B(x,y) for the bone region corresponding to other bones included in the bone part image Gb. Hereinafter, the bone region from which the first derivation unit 23 derives the bone density B(x,y) refers to the bone region corresponding to the lumbar vertebra.

Specifically, the first derivation unit 23 derives the bone density B(x,y) corresponding to each pixel by converting each pixel value Gb(x,y) of the bone region of the bone part image Gb into the pixel value of the bone part image in a case of being acquired under a standard imaging condition. More specifically, the first derivation unit 23 derives the bone density B(x,y) for each pixel by correcting each pixel value Gb(x,y) of the bone part image Gb by using the correction coefficient acquired from a look-up table (not shown) described below.

Here, a contrast between a soft part and a bone part in the radiation image is lower as the tube voltage in the radiation source 3 is higher and the energy of the radiation emitted from the radiation source 3 is higher. In addition, in a procedure of the radiation transmitted through the subject H, a low-energy component of the radiation is absorbed by the subject H, and beam hardening occurs in which the radiation energy is increased. The increase in the radiation energy due to the beam hardening is larger as the body thickness of the subject H is larger.

FIG. 5 is a diagram showing a relationship between the contrast of the bone part and the soft part with respect to the body thickness of the subject H. Note that FIG. 5 shows the relationship of the contrast between the bone part and the soft part with respect to the body thickness of the subject H at the three tube voltages of 80 kV, 90 kV, and 100 kV. As shown in FIG. 5, the contrast is lower as the tube voltage is higher. In addition, in a case in which the body thickness of the subject H exceeds a certain value, the contrast is lower as the body thickness is larger. Note that contrast between the bone part and the soft part is higher as the pixel value Gb(x,y) of the bone region in the bone part image Gb is larger. Therefore, the relationship shown in FIG. 5 shifts to a higher contrast side as the pixel value Gb(x,y) of the bone region in the bone part image Gb is increased.

In the present embodiment, the look-up table (not shown) for acquiring the correction coefficient for correcting the difference in the contrast depending on the tube voltage during imaging and the decrease in the contrast due to the influence of the beam hardening in the bone part image Gb is stored in the storage 13. The correction coefficient is the coefficient for correcting each pixel value Gb(x,y) of the bone part image Gb.

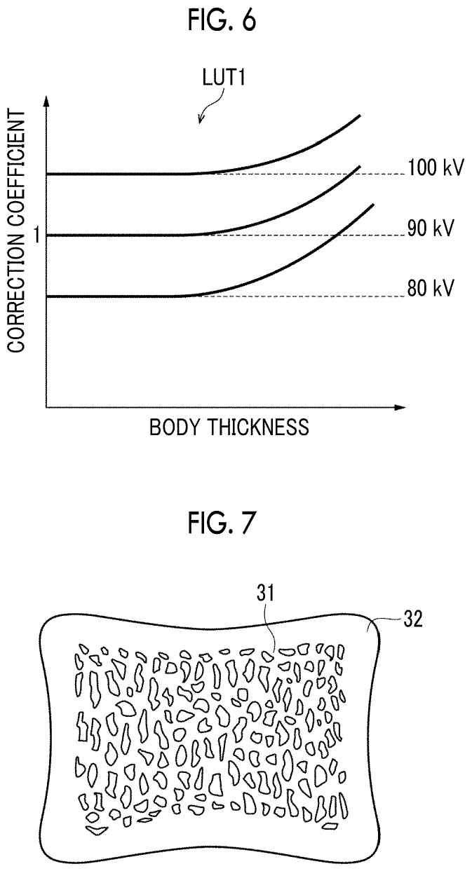

FIG. 6 is a diagram showing an example of the look-up table stored in the storage 13. In FIG. 6, a look-up table LUT1 in which the standard imaging condition is set to the tube voltage of 90 kV is shown. As shown in FIG. 6, in the look-up table LUT1, the correction coefficient is set to be larger as the tube voltage is higher and the body thickness of the subject is larger. In the example shown in FIG. 6, since the standard imaging condition is the tube voltage of 90 kV, the correction coefficient is 1 in a case in which the tube voltage is 90 kV and the body thickness is 0. Note that although the look-up table LUT1 is shown in two dimensions in FIG. 6, the correction coefficient differs depending on the pixel value of the bone region. Therefore, the look-up table LUT1 is actually a three-dimensional table to which an axis representing the pixel value of the bone region is added.

The first derivation unit 23 extracts the body thickness distribution T(x,y) of the subject H and a correction coefficient CO(x,y) for each pixel depending on the imaging conditions including a set value of the tube voltage stored in the storage 13 from the look-up table LUT1. Moreover, as shown in Expression (2), the first derivation unit 23 multiplies each pixel value Gb(x,y) of the bone region in the bone part image Gb by the correction coefficient CO(x,y) to derive a bone density B(x,y) for each pixel of the bone part image Gb. As a result, the bone density image B having the bone density B(x,y) as the pixel value is derived. The bone density B(x,y) derived in this way is acquired by imaging the subject H by the tube voltage of 90 kV, which is the standard imaging condition, and represents the pixel value of the bone part of the bone region included in the radiation image from which the influence of the beam hardening is removed.

B(x,y)=CO(x,y)×Gb(x,y) (2)

Note that the first derivation unit 23 may derive the bone density image B by deriving a low-frequency component of the distribution of the bone density B(x,y) of each pixel of the bone part image Gb and using the derived low-frequency component as the pixel value. In addition, the bone density image B may be derived by deriving a representative value of the bone density B(x,y) of each pixel of the bone part image Gb and using the derived representative value as the pixel value. For example, an average value, a median value, a maximum value, or a minimum value can be used as the representative value. As a result, in a case in which the bone density image B is displayed, it is possible to confirm a global change in the bone density.

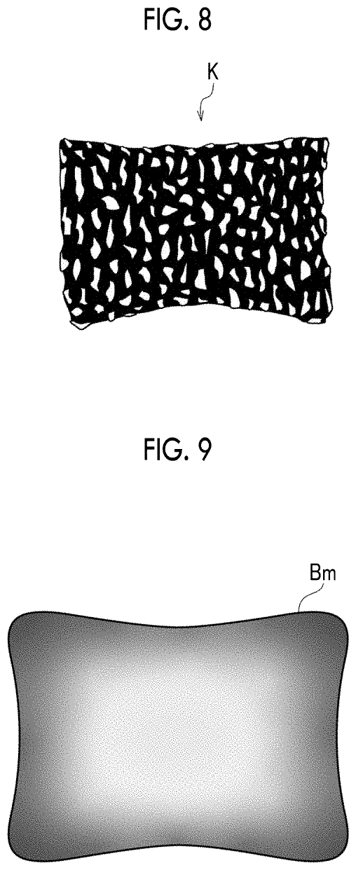

The second derivation unit 24 derives a trabecula image K representing the trabecula structure from the first radiation image G1, the second radiation image G2, or the bone part image Gb. In the present embodiment, the trabecula image K is derived from the bone part image Gb. FIG. 7 is a cross-sectional view of a vertebra, which is an example of a cross-sectional structure of a human bone. As shown in FIG. 7, the human bone includes a cancellous bone 31 and a cortical bone 32 that covers the outside of the cancellous bone 31. The cortical bone 32 is harder and denser than the cancellous bone 31. The cancellous bone 31 extends into a medullary cavity, which is called the trabecula. The trabecula is a collection of small bone columns. Since the trabecula is composed of a bone plate and a grid of columns, the trabecula structure appears as a high-frequency component in the image. Therefore, the second derivation unit 24 derives the high-frequency component of the image of the bone region in the bone part image Gb as the trabecula image K. Here, a pixel value K(x,y) of the trabecula image K is a value of the high-frequency component of the image of the bone region in the bone part image Gb. FIG. 8 shows the derived trabecula image. In FIG. 8, the derived trabecula image K is shown at high concentration. Note that, by using band information of about 0.1 to 0.2 cycle/mm or more in the bone part image Gb as the high-frequency component, the trabecula image K including the trabecula and bone cortex component information can be derived. In addition, by using band information of about 0.4 to 1.0 cycle/mm or more in the bone part image Gb as the high-frequency component, the trabecula image K including only a thin line of the trabecula can be derived. On the other hand, the low-frequency component in a case of deriving the low-frequency component of the distribution of the bone density B(x,y) described above as the bone density image B is a frequency component in a band other than the band of the high-frequency component described above.

Note that, since the contrast of the high-frequency component of the image of the bone region in the bone part image Gb is small, the contrast is difficult to be visually recognized, in some cases. Therefore, the second derivation unit 24 may enhance the high-frequency component and derive the enhanced high-frequency component as the trabecula image K.

The display controller 25 superimposes the trabecula image K on the bone density image B and displays the trabecula image K and the bone density image B on the display 14. Specifically, the display controller 25 generates a composite image GC0 by superimposing the trabecula image K on the bone density image B, and displays the generated composite image GC0 on the display 14. In a case of generating the composite image GCO, the display controller 25 maps different colors to the bone density image B in accordance with the value of the bone density B(x,y) to generate a mapping image Bm. FIG. 9 is a diagram showing the mapping image. In FIG. 9, the difference in colors is shown by the concentration difference, and the bone density is higher as the concentration is higher. As a result, the mapping image

Bm has a color distribution corresponding to the bone density in the bone density image B. Note that, in the mapping image Bm, a concentration change in accordance with the bone density may be represented instead of the color mapping.

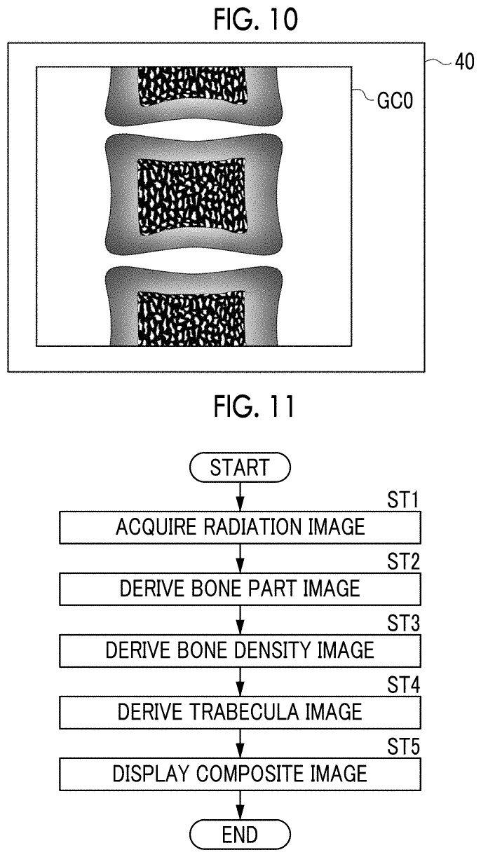

Moreover, the display controller 25 derives the composite image GC0 by superimposing the trabecula image K on the mapping image Bm. FIG. 10 is a diagram showing a display screen of the composite image. Note that, in a display screen 40 shown in FIG. 10, only a vertebra region of the bone part image Gb shown in FIG. 4 is enlarged and displayed. In FIG. 10, it is preferable that the color of the trabecula image K be different from the color of the mapping image Bm. For example, in a case in which the color of the mapping image Bm is a cool color, it is preferable that the color of the trabecula image K be a warm color.

More specifically, in the mapping image Bm, in a case in which the bone density B(x,y) is expressed by N-stage color change by setting the minimum bone density as green ((R, G, B)=(0, 255, 0)) and the maximum bone density as blue (0, 0, 255), the pixel value of the mapping image Bm is derived by (0, 255−255×(n−1)/N, 255×(n−1)/N) (n=1, 2, . . . N). n indicates a range to which the bone density B(x,y) belongs in a case in which a range from the minimum value to the maximum value that the bone density B(x,y) can take is divided into N pieces. For example, in a case in which N=16 in a case in which the bone density B(x,y) takes a value of 0 to 255, n=1 in a case in which the bone density B(x,y) of a certain pixel is 10, n=8 in a case in which the bone density B(x,y) of a certain pixel is 120, and n=16 in a case in which the bone density B(x,y) of a certain pixel is 250. On the other hand, in the trabecula image K, in a case in which the pixel value K(x,y) of the trabecula image K is expressed by M-stage color change by setting the minimum pixel value as yellow (255, 255, 0)) and the maximum pixel value as red (255, 0, 0), the pixel value K(x,y) of the trabecula image K is derived by (255, 255−255×(m—1)/M, 255×(m−1)/M) (m=1, 2, . . . M). In this case, a case in which the color of the trabecula image K is different from the color of the mapping image Bm means that the color of the mapping image Bm and the color of the trabecula image K do not match in any of n or m described above.

Note that the color changes of the mapping image Bm and the trabecula image K may not be linear. For example, the pixel value of the mapping image Bm may be derived by (0, 255−255×(n−1)²/N², 255×(n−1)²/N²) and the pixel value of the trabecula image K may be derived by (255, 255−255×(m−1)²/M², 255×(m−1)²/M²).

Then, processing performed in the present embodiment will be described. FIG. 11 is a flowchart showing the processing performed in the present embodiment. First, the image acquisition unit 21 causes the imaging apparatus 1 to perform imaging to acquire the first and second radiation images G1 and G2 having different energy distributions from each other (step ST1). Then, the bone part image generation unit 22 derives the bone part image Gb representing the bone region of the subject H from the first radiation image G1 and the second radiation image G2 acquired by the image acquisition unit 21 (step ST2).

Subsequently, the first derivation unit 23 derives the bone density image B representing the bone density in the bone region of the subject H based on the bone part image Gb generated by the bone part image generation unit 22 (step ST3). Further, the second derivation unit 24 derives the trabecula image K that represents the trabecula structure from the bone part image Gb (step ST4). Moreover, the trabecula image K is superimposed on the bone density image B to derive the composite image GCO, and the derived composite image GC0 is displayed on the display 14 (step ST5), and the processing is terminated.

As described above, in the present embodiment, since the trabecula image K is superimposed and displayed on the bone density image B, it is possible to confirm the bone density and the trabecula structure at a glance.

In addition, by making the colors of the bone density image B and the trabecula image K different, both the bone density image B and the trabecula image K can be easily distinguished and confirmed.

In addition, in the embodiment described above, the first and second radiation images G1 and G2 are acquired by the one-shot method in a case in which the energy subtraction processing is performed, but the present disclosure is not limited to this. The first and second radiation images G1 and G2 may be acquired by a so-called two-shot method in which imaging is performed twice by using only one radiation detector. In a case of the two-shot method, there is a possibility that a position of the subject H included in the first radiation image G1 and the second radiation image G2 shifts due to a body movement of the subject H. Therefore, in the first radiation image G1 and the second radiation image G2, it is preferable to perform the processing according to the present embodiment after registration of the subject is performed.

In addition, in the embodiment described above, the visceral fat mass distribution is derived by using the first and second radiation images acquired by the system that images the subject H by using the first and second radiation detectors 5 and 6, but the visceral fat mass distribution may be derived from the first and second radiation images G1 and G2 acquired by using an accumulative phosphor sheet instead of the radiation detector. In this case, the first and second radiation images G1 and G2 need only be acquired by stacking two accumulative phosphor sheets, emitting the radiation transmitted through the subject H, accumulating and recording radiation image information of the subject H in each of the accumulative phosphor sheets, and photoelectrically reading the radiation image information from each of the accumulative phosphor sheets. Note that the two-shot method may also be used in a case in which the first and second radiation images G1 and G2 are acquired by using the accumulative phosphor sheet.

In addition, the radiation in the embodiment described above is not particularly limited, and x-rays or y-rays can be used in addition to X-rays.

In addition, in the embodiment described above, various processors shown below can be used as the hardware structure of processing units that execute various pieces of processing, such as the image acquisition unit 21, the bone part image generation unit 22, the first derivation unit 23, the second derivation unit 24, and the display controller 25. As described above, the various processors include, in addition to the CPU that is a general-purpose processor which executes software (program) and functions as various processing units, a programmable logic device (PLD) that is a processor whose circuit configuration can be changed after manufacture, such as a field programmable gate array (FPGA), and a dedicated electric circuit that is a processor having a circuit configuration which is designed for exclusive use in order to execute a specific processing, such as an application specific integrated circuit (ASIC).

One processing unit may be configured by one of these various processors, or may be configured by a combination of two or more processors of the same type or different types (for example, a combination of a plurality of FPGAs or a combination of the CPU and the FPGA). In addition, a plurality of the processing units may be configured by one processor.

As an example of configuring the plurality of processing units by one processor, first, as represented by a computer, such as a client and a server, there is an aspect in which one processor is configured by a combination of one or more CPUs and software and this processor functions as a plurality of processing units. Second, as represented by a system on chip (SoC) or the like, there is an aspect of using a processor that realizes the function of the entire system including the plurality of processing units by one integrated circuit (IC) chip. In this way, as the hardware structure, the various processing units are configured by using one or more of the various processors described above.

Moreover, as the hardware structure of these various processors, more specifically, it is possible to use an electrical circuit (circuitry) in which circuit elements, such as semiconductor elements, are combined.

What is claimed is:

1. An image processing device comprising:
at least one processor,
wherein the processor
derives a bone part image of a subject including a bone part from a first radiation image and a second radiation image acquired by imaging the subject with radiation having different energy distributions,
derives a bone density image representing bone density in a bone region of the subject from the bone part image,
derives a trabecula image representing a trabecula structure from the first radiation image, the second radiation image, or the bone part image, and
superimposes the trabecula image on the bone density image to display the trabecula image and the bone density image.

2. The image processing device according to claim 1,
wherein the processor derives a high-frequency component of the first radiation image, the second radiation image, or the bone part image as the trabecula image.

3. The image processing device according to claim 2,
wherein the processor derives an enhanced high-frequency component as the trabecula image.

4. The image processing device according to claim 1,
wherein the processor
derives the bone density of each pixel in the bone region, and
derives the bone density image having a low-frequency component of a distribution of the bone density as a pixel value.

5. The image processing device according to claim 1,
wherein the processor
derives the bone density of each pixel in the bone region, and
derives the bone density image having a representative value of the bone density in the bone region as a pixel value.

6. The image processing device according to claim 1,
wherein the bone density image has a color distribution corresponding to the bone density.

7. The image processing device according to claim 6,
wherein the trabecula image has a color different from the bone density.

8. An image processing method comprising:
deriving a bone part image of a subject including a bone part from a first radiation image and a second radiation image acquired by imaging the subject with radiation having different energy distributions;
deriving a bone density image representing bone density in a bone region of the subject from the bone part image;
deriving a trabecula image representing a trabecula structure from the first radiation image, the second radiation image, or the bone part image; and
superimposing the trabecula image on the bone density image to display the trabecula image and the bone density image.

9. A non-transitory computer-readable storage medium that stores an image processing program causing a computer to execute:
a procedure of deriving a bone part image of a subject including a bone part from a first radiation image and a second radiation image acquired by imaging the subject with radiation having different energy distributions;
a procedure of deriving a bone density image representing bone density in a bone region of the subject from the bone part image;
a procedure of deriving a trabecula image representing a trabecula structure from the first radiation image, the second radiation image, or the bone part image; and
a procedure of superimposing the trabecula image on the bone density image to display the trabecula image and the bone density image.
